(19) United States
(12) Patent Application Publication
(10) Pub. No.: US 2026/0338250 A1
(43) Pub. Date: Oct. 29, 2026

(54) SHOCK ABSORBER

(71) Applicant: Hitachi Astemo, Ltd., Hitachinaka-shi (JP)

(72) Inventors: Takahiro MORI, Hitachinaka-shi (JP); Osamu YUNO, Hitachinaka-shi (JP); Takao NAKADATE, Hitachinaka-shi (JP)

(21) Appl. No.: 19/733,225

(22) Filed: Jul. 7, 2026

Related U.S. Application Data
(62) Division of application No. 18/273,586, filed on Feb. 1, 2022.

(30) Foreign Application Priority Data
Feb. 4, 2021 (JP) 2021-016764

(51) Int. Cl. F16F 9/348; F16F 9/19; F16F 9/48

(52) U.S. Cl. CPC F16F 9/348; F16F 9/19; F16F 9/48

(57) ABSTRACT

The present invention causes a low-rigidity disk to be supported by a backup disk (a deformation prevention portion), and therefore can prevent the low-rigidity disk from being deformed due to an inflow of hydraulic oil to between the low-rigidity disk and a disk adjacent thereto according to an increase in a pressure in a cylinder upper chamber during an extension stroke, and can improve the durability of the low-rigidity disk.

### CROSS REFERENCE TO RELATED APPLICATIONS

This application is a divisional of U.S. Application No. 18/273,586, which is the U.S. National Stage of PCT International Patent Application Number PCT/JP2022/003732 filed on Feb. 1, 2022, which claims the benefit of priority of Japanese Application No. 2021-016764 filed on Feb. 4, 2021. The entire disclosures of the above-identified applications, including the specifications, drawings and claims are incorporated herein by reference in their entirety.

### TECHNICAL FIELD

The present invention relates to a damping force adjustable shock absorber that adjusts a damping force by controlling a flow of hydraulic fluid in reaction to a stroke of a piston rod.

### BACKGROUND ART

In a damping force adjustable shock absorber that adjusts a damping force using an actuator (for example, refer to "PTL 1"), a low-rigidity disk can be effectively used as a disk seated on a seat portion of a main valve when a damping force according to a soft characteristic is necessary. This allows the main valve to be opened at earlier timing, thereby allowing a damping force to be acquired according to a low valve characteristic.

### CITATION LIST

### PATENT LITERATURE

PTL 1: Japanese Patent Application Public Disclosure No. 2008-89037

### SUMMARY OF INVENTION

### TECHNICAL PROBLEM

Then, using the low-rigidity disk may lead to entry of hydraulic oil into between the low-rigidity disk seated on the seat portion and a disk adjacent to this low-rigidity disk upon an increase in a pressure in a cylinder upper chamber over a pressure in a compression-side back-pressure chamber, for example, during an extension stroke, resulting in a deformation of the low-rigidity disk and a reduction in the durability.

One of the objects of the present invention is to provide a shock absorber having improved durability.

### SOLUTION TO PROBLEM

According to the present invention, a shock absorber includes a cylinder sealingly containing hydraulic fluid therein, a piston movably provided in the cylinder and partitioning an inside of the cylinder into two chambers, a piston rod having one end side coupled with the piston and an opposite end side extending out of the cylinder, a passage in which a flow of the hydraulic fluid is generated due to a movement of the piston in one direction, a passage formation member including the passage formed therein, a main valve configured to apply a resistance force to a flow of the hydraulic fluid passing through the passage formation member from a chamber on an upstream side to a chamber on a downstream side, a back-pressure chamber configured to apply an inner pressure in a valve-closing direction of the main valve, and a bottomed tubular case member. The bottomed tubular case member includes a tube portion and a bottom portion. The tube portion includes an opening portion opened on one end side thereof. The main valve is disposed in the opening portion. The back-pressure chamber is formed inside the bottomed tubular case member. The shock absorber further includes an inner seat portion provided on the passage formation member and disposed on an inner peripheral side with respect to an opening of the passage, an outer seat portion disposed on an outer peripheral side with respect to the opening of the passage, a low-rigidity disk configured to be seated on the outer seat portion and having lower rigidity than the main valve, and a deformation prevention portion configured to prevent the low-rigidity disk from being deformed.

According to one aspect of the present invention, the durability of the shock absorber can be improved.

### BRIEF DESCRIPTION OF DRAWINGS

FIG. 1 is a cross-sectional view of a shock absorber according to a first embodiment taken along an axial plane.

FIG. 2 is an enlarged view illustrating a valve mechanism portion illustrated in FIG. 1.

FIG. 3 is an enlarged view illustrating a part of an extension-side valve mechanism portion illustrated in FIG. 2.

FIG. 4 is a plan view of a low-rigidity disk used in the first embodiment.

FIG. 5 is an enlarged view illustrating a part of a compression-side valve mechanism portion illustrated in FIG. 2.

FIG. 6 illustrates a second embodiment.

FIG. 7 is a plan view of a low-rigidity disk used in the second embodiment.

FIG. 8 illustrates a third embodiment.

FIG. 9 illustrates a hydraulic circuit diagram according to the third embodiment.

FIG. 10 is a plan view of a check valve according to the third embodiment.

FIG. 11 illustrates another configuration of the third embodiment.

FIG. 12 illustrates a fourth embodiment.

### DESCRIPTION OF EMBODIMENTS

### First Embodiment

A first embodiment of the present invention will be described with reference to the attached drawings.

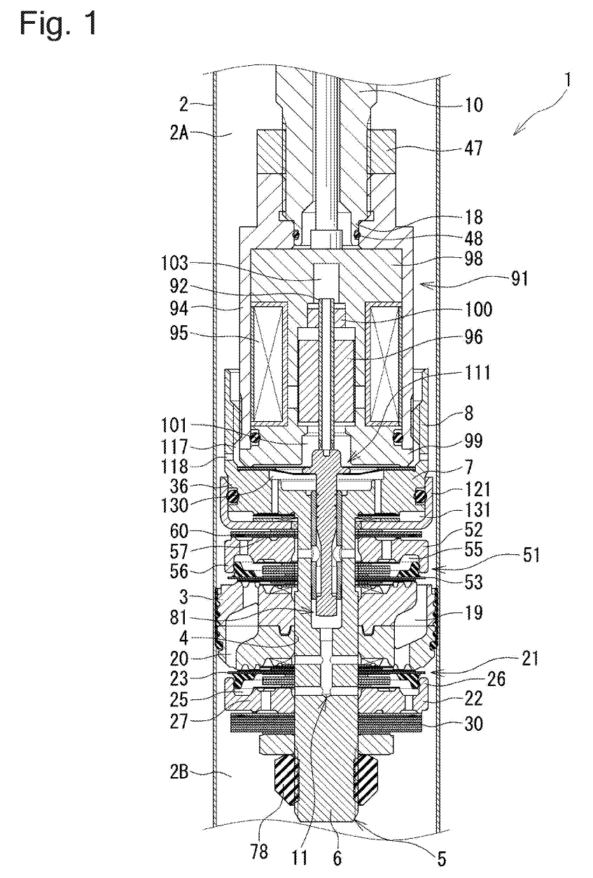

For convenience, the vertical direction in FIG. 1 will be referred to as a "vertical direction" herein simply. The first embodiment will be described citing a single tube-type damping force adjustable shock absorber in the following description, but can also be applied to a twin tube-type damping force adjustable shock absorber including a reservoir.

As illustrated in FIG. 1, a shock absorber 1 is a damping force adjustable shock absorber including a damping force adjustment mechanism built in a cylinder 2. A piston 3 is slidably fittedly inserted in the cylinder 2. The piston 3 partitions the inside of the cylinder 2 into two chambers, a cylinder upper chamber 2A and a cylinder lower chamber 2B. A free piston (not illustrated) vertically movable in the cylinder 2 is provided in the cylinder 2. This free piston partitions the inside of the cylinder 2 into the cylinder lower chamber 2B on the piston 3 side (the upper side) and a gas chamber (not illustrated) on the bottom side (the lower side).

A shaft portion 6 of a piston bolt 5 is inserted through an axial hole 4 of the piston 3. The piston bolt 5 includes a head portion 7 and a cylindrical portion 8. The head portion 7 is provided at the upper end portion of the shaft portion 6. The cylindrical portion 8 is formed on the outer peripheral edge portion of this head portion 7. The cylindrical portion 8 is opened on the upper end side thereof, and has a larger outer diameter than the head portion 7. An extension-side passage 19 and a compression-side passage 20 are provided in the piston 3. The upper end of the extension-side passage 19 is opened to the cylinder upper chamber 2A. The lower end of the compression-side passage 20 is opened to the cylinder lower chamber 2B. An extension-side valve mechanism 21 is provided on the lower end side of the piston 3. The extension-side valve mechanism 21 controls a flow of hydraulic fluid in the extension-side passage 19. On the other hand, a compression-side valve mechanism 51 is provided on the upper end side of the piston 3. The compression-side valve mechanism 51 controls a flow of hydraulic fluid in the compression-side passage 20.

The extension-side valve mechanism 21 includes a bottomed cylindrical extension-side pilot case 22 (a case member) attached to the shaft portion 6 of the piston bolt 5. The extension-side pilot case 22 includes a cylindrical portion 26 opened on the piston 3 side and a bottom portion 27, with an extension-side main valve 23 disposed on the piston 3 side and a back-pressure chamber 25 formed therein. The extension-side valve mechanism 21 includes a seat portion 24 and the extension-side back-pressure chamber 25. The seat portion 24 is formed on the outer peripheral side of the lower end surface of the piston 3. The extension-side main valve 23 is in abutment with the seat portion 24 in a seatable and separable manner. The extension-side back-pressure chamber 25 is formed between the extension-side pilot case 22 and the back surface of the extension-side main valve 23. A pressure in the extension-side back-pressure chamber 25 is applied to the extension-side main valve 23 in a valve-closing direction. The extension-side main valve 23 is a packing valve in which an annular packing 31 made of an elastic member is in contact with the inner peripheral surface of the cylindrical portion 26 of the extension-side pilot case 22 along the entire circumference thereof.

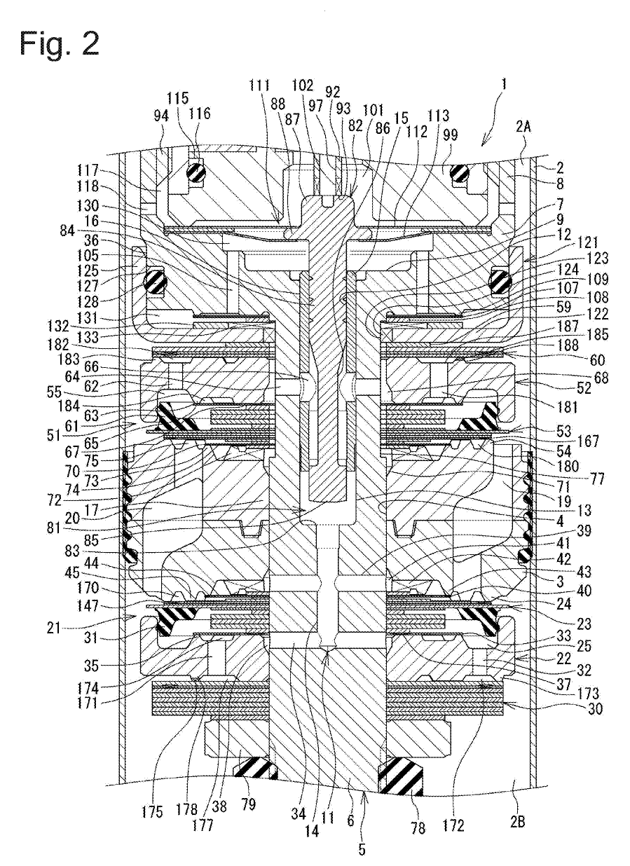

As illustrated in FIG. 2, the extension-side back-pressure chamber 25 is in communication with the cylinder lower chamber 2B via passages 32 formed in the bottom portion 27 of the extension-side pilot case 22 and a sub valve 30. The sub valve 30 is opened when the pressure in the extension-side back-pressure chamber 25 reaches a predetermined pressure, and applies a resistance force to a flow of the hydraulic fluid directed from the extension-side back-pressure chamber 25 to the cylinder lower chamber 2B. The extension-side back-pressure chamber 25 is in communication with first pressure-receiving chambers 172 formed between the extension-side pilot case 22 and the sub valve 30 via the passages 32. The first pressure-receiving chambers 172 are defined by an endless first seat portion 173 provided on the lower end surface of the extension-side pilot case 22 (the surface thereof opposite from the extension-side main valve 23 side). The passages 32 are opened on the inner side with respect to the first seat portion 173. The first pressure-receiving chambers 172 are evenly disposed at circumferential intervals on the lower end surface of the extension-side pilot case 22.

A back-pressure introduction passage 171 is provided in the extension-side pilot case 22. In the back-pressure introduction passage 171, a flow of the hydraulic fluid from the cylinder lower chamber 2B to the extension-side back-pressure chamber 25 is generated due to a movement of the piston 3 in a compression direction. An annular seat portion 35 is provided on the upper end surface of the extension-side pilot case 22 (the surface thereof on the extension-side main valve 23 side). The seat portion 35 defines an annular pressure-receiving chamber 174 provided on the outer periphery of the inner peripheral portion of the bottom portion 27. The seat portion 35 is located at the same height in the axial direction (the "vertical direction" in FIG. 2) as the upper end surface of the inner peripheral portion of the bottom portion 27.

A second pressure-receiving chamber 177 isolated from the first pressure-receiving chambers 172 is provided on the lower end surface of the extension-side pilot case 22. The back-pressure introduction passage 171 is opened to the second pressure-receiving chamber 177. The second pressure-receiving chamber 177 is defined by a second seat portion 178. The second seat portion 178 extends in a circular arc form between a pair of adjacent first pressure-receiving chambers 172. A first orifice 175 is provided on the second seat portion 178. The first orifice 175 establishes communication between the second pressure-receiving chamber 177 and the cylinder lower chamber 2B. Due to this configuration, an extension-side communication passage (a communication passage) establishing communication between the cylinder lower chamber 2B and the extension-side back-pressure chamber 25 is formed in the extension-side valve mechanism 21. Through the extension-side communication passage, the hydraulic fluid in the cylinder lower chamber 2B is introduced into the extension-side back-pressure chamber 25 via the first orifice 175, the second pressure-receiving chamber 177, the back-pressure introduction passage 171, the pressure-receiving chamber 174, and a check valve 33 according to the movement of the piston 3 in the compression direction.

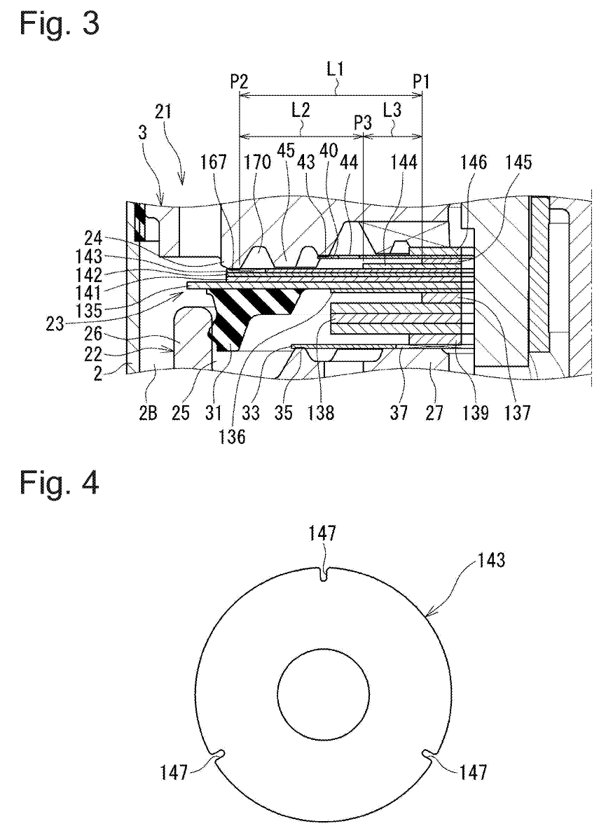

As illustrated in FIG. 3, the disk-like check valve 33 is in abutment with the seat portion 35 in a seatable and separable manner. The check valve 33 permits a flow of the hydraulic fluid from the back-pressure introduction passage 171 to the extension-side back-pressure chamber 25. A disk 136, a spacer 137, a retainer 138 formed by stacking three disks, a spacer 139, and the check valve 33 are stacked in this order from the main disk 135 side between the inner peripheral portion of the bottom portion 27 of the extension-side pilot case 22 and the main disk 135 including the packing 31 joined to the outer peripheral portion of the surface thereof on the extension-side pilot case 22 side.

On the other hand, a disk 141, a disk 142, a low-rigidity disk 143, a backup disk 144 (a deformation prevention portion), a spacer 145, a disk valve 40, and a spacer 146 are stacked in this order from the main disk 135 side between an inner peripheral portion 17 of the piston 3 and the main disk 135. Then, the outer diameters of the disk 141, the disk 142, and the low-rigidity disk 143 are equal to one another, and are smaller than the outer diameter of the main disk 135. Further, the outer diameter of the backup disk 144 is smaller than the outer diameter of the low-rigidity disk 143.

The outer peripheral edge portion of the low-rigidity disk 143 is in abutment with the seat portion 24 (an outer seat portion) of the piston 3 (a passage formation member) in a seatable and separable manner. A seat portion 45 (an inner seat portion) is provided on the inner peripheral side with respect to the seat portion 24 of the piston 3. The seat portion 45 receives the surface of the extension-side main valve 23 (the low-rigidity disk 143) on the piston 3 side. A plurality ("three" in the first embodiment) of cutouts 147 (refer to FIG. 4) is formed on the outer peripheral edge portion of the low-rigidity disk 143. The cutouts 147 serve as orifices that establish communication of an extension-side main pressure-receiving chamber 170 formed on the inner side with respect to the seat portion 24 with the cylinder lower chamber 2B.

The compression-side valve mechanism 51 includes the bottomed cylindrical compression-side pilot case 52 (the case member) attached to the shaft portion 6 of the piston bolt 5. The compression-side pilot case 52 includes a cylindrical portion 56 opened on the piston 3 side and a bottom portion 57, with a compression-side main valve 53 disposed on the piston 3 side and a compression-side back-pressure chamber 55 formed therein. The compression-side valve mechanism 51 includes a seat portion 54 and the compression-side back-pressure chamber 55. The seat portion 54 is formed on the outer peripheral side of the upper end surface of the piston 3, and the compression-side main valve 53 is in abutment with the seat portion 54 in a seatable and separable manner. The compression-side back-pressure chamber 55 is formed between the compression-side pilot case 52 and the back surface of the compression-side main valve 53. The pressure in the compression-side back-pressure chamber 55 is applied to the compression-side main valve 53 in a valve-closing direction. The compression-side main valve 53 is a packing valve in which an annular packing 61 made of an elastic member is in contact with the inner peripheral surface of the cylindrical portion 56 of the compression-side pilot case 52 along the entire circumference thereof.

As illustrated in FIG. 2, the compression-side back-pressure chamber 55 is in communication with the cylinder upper chamber 2A via passages 62 formed in the bottom portion 57 of the compression-side pilot case 52 and a sub valve 60. The sub valve 60 is opened when the pressure in the compression-side back-pressure chamber 55 reaches a predetermined pressure, and applies a resistance force to a flow of the hydraulic fluid directed from the compression-side back-pressure chamber 55 to the cylinder upper chamber 2A. The compression-side back-pressure chamber 55 is in communication with first pressure-receiving chambers 182 formed between the compression-side pilot case 52 and the sub valve 60 via the passages 62. The first pressure-receiving chambers 182 are defined by an endless first seat portion 183 provided on the upper end surface of the compression-side pilot case 52 (the surface thereof opposite from the compression-side main valve 53 side). The passages 62 are opened on the inner side with respect to the first seat portion 183. The first pressure-receiving chambers 182 are evenly disposed at circumferential intervals on the upper end surface of the compression-side pilot case 52.

A back-pressure introduction passage 181 is provided in the compression-side pilot case 52. In the back-pressure introduction passage 181, a flow of the hydraulic fluid from the cylinder upper chamber 2A to the compression-side back-pressure chamber 55 is generated due to a movement of the piston 3 in an extension direction. An annular seat portion 65 is provided on the lower end surface of the compression-side pilot case 52 (the surface thereof on the compression-side main valve 53 side). The seat portion 65 defines an annular pressure-receiving chamber 184 provided on the outer periphery of the inner peripheral portion of the bottom portion 57. The seat portion 65 is located at the same height in the axial direction (the "vertical direction" in FIG. 2) as the lower end surface of the inner peripheral portion of the bottom portion 57.

A second pressure-receiving chamber 187 isolated from the first pressure-receiving chambers 182 is provided on the upper end surface of the compression-side pilot case 52. The back-pressure introduction passage 181 is opened to the second pressure-receiving chamber 187. The second pressure-receiving chamber 187 is defined by a second seat portion 188. The second seat portion 188 extends in a circular arc form between a pair of adjacent first pressure-receiving chambers 182. A first orifice 185 is provided on the second seat portion 188. The first orifice 185 establishes communication between the second pressure-receiving chamber 187 and the cylinder upper chamber 2A. Due to this configuration, a compression-side communication passage (a communication passage) establishing communication between the cylinder upper chamber 2A and the compression-side back-pressure chamber 55 is formed in the compression-side valve mechanism 51. Through the compression-side communication passage, the hydraulic fluid in the cylinder upper chamber 2A is introduced into the compression-side back-pressure chamber 55 via the first orifice 185, the second pressure-receiving chamber 187, the back-pressure introduction passage 181, the pressure-receiving chamber 184, and a check valve 63 according to the movement of the piston 3 in the extension direction.

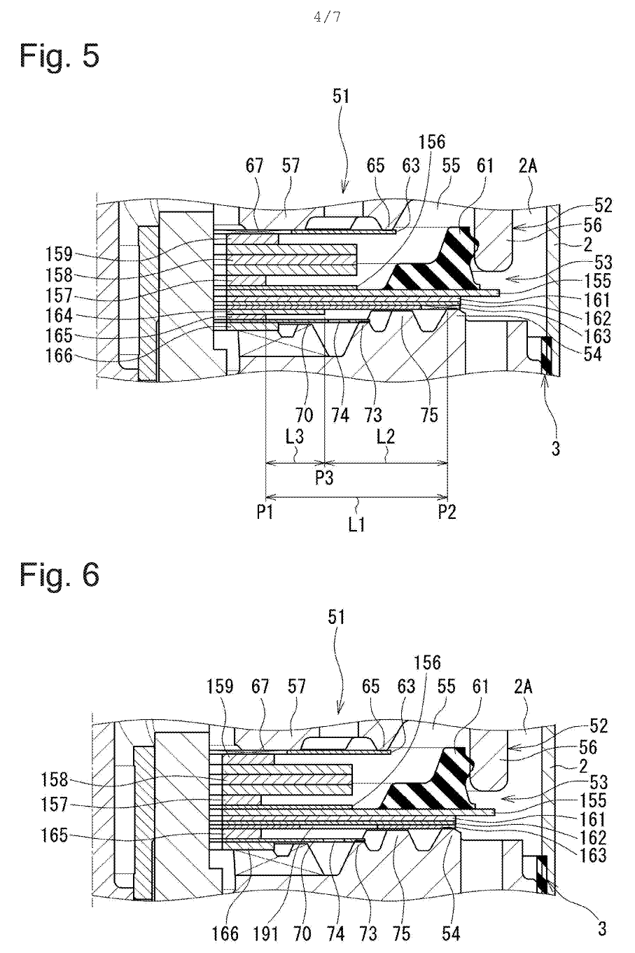

As illustrated in FIG. 5, the disk-like check valve 63 is in abutment with the seat portion 65 in a seatable and separable manner. The check valve 63 permits a flow of the hydraulic fluid from the back-pressure introduction passage 181 to the compression-side back-pressure chamber 55. A disk 156, a spacer 157, a retainer 158 formed by stacking three disks, a spacer 159, and the check valve 63 are stacked in this order from the main disk 155 side between the inner peripheral portion of the bottom portion 57 of the compression-side pilot case 52 and the main disk 155 including the packing 61 joined to the outer peripheral portion of the surface thereof on the compression-side pilot case 52 side.

On the other hand, a disk 161, a disk 162, a low-rigidity disk 163, a backup disk 164 (the deformation prevention portion), a spacer 165, a disk valve 70, and a spacer 166 are stacked in this order from the main disk 155 side between the inner peripheral portion 17 of the piston 3 and the main disk 155. Then, the outer diameters of the disk 161, the disk 162, and the low-rigidity disk 163 are equal to one another, and are smaller than the outer diameter of the main disk 155. Further, the outer diameter of the backup disk 164 is smaller than the outer diameter of the low-rigidity disk 163.

The outer peripheral edge portion of the low-rigidity disk 163 is in abutment with the seat portion 54 (the outer seat portion) of the piston 3 in a seatable and separable manner. A seat portion 75 (the inner seat portion) is provided on the inner peripheral side with respect to the seat portion 54 of the piston 3. The seat portion 75 receives the surface of the compression-side main valve 53 (the low-rigidity disk 163) on the piston 3 side. A plurality ("three" in the first embodiment) of cutouts 167 (refer to FIG. 4) is formed on the outer peripheral edge portion of the low-rigidity disk 163. The cutouts 167 serve as orifices that establish communication of a compression-side main pressure-receiving chamber 180 formed on the inner side with respect to the seat portion 54 with the cylinder upper chamber 2A.

The valve members of the extension-side valve mechanism 21 and the compression-side valve mechanism 51 are pressed between the head portion 7 of the piston bolt 5 and a washer 79 and subjected to an axial force by tightening a nut 78 attached to a screw portion (not labeled) of the shaft portion 6 of the piston bolt 5.

On the other hand, a common passage 11 is formed in the piston bolt 5. The common passage 11 includes an axial passage 12 formed inside a sleeve 15 (an axial hole). The upper end of the sleeve 15 is fittedly attached in a hole 16 opened on the head portion 7 of the piston bolt 5. The common passage 11 includes an axial passage 13 formed at the lower portion of the hole 16 (a portion on the lower side with respect to the lower end of the sleeve 15). The common passage 11 includes an axial passage 14 constituted by a small-diameter hole opened to the hole 16 at the upper end thereof. The inner diameter of the common passage 11 is maximized at the axial passage 13, and is reducing in an order of the axial passage 12 and the axial passage 14. The axial passage 12 is opened on an end surface 9 of the head portion 7 of the piston bolt 5.

Referring to FIGS. 1 and 2, the lower end portion of the piston rod 10 is connected to the upper end portion of a solenoid case 94 by screw coupling. The upper end side of the piston rod 10 extends out of the cylinder 2. A nut 47 serving as a loose stopper is attached to the lower end portion (a screw portion) of the piston rod 10. A small-diameter portion 18 is formed at the lower end portion of the piston rod 10 (on the lower side with respect to the screw portion). A seal member 48 is set in an annular groove (not labeled) formed on the outer peripheral surface of the small-diameter portion 18. The seal member 48 seals between the solenoid case 94 and the piston rod 10.

The extension-side back-pressure chamber 25 is in communication with a radial passage 34 formed in the shaft portion 6 of the piston bolt 5 via an orifice 37 provided on the inner peripheral portion of the check valve 33 and an annular passage 38 formed on the inner peripheral portion of the bottom portion 27 of the extension-side pilot case 22. The radial passage 34 is in communication with the axial passage 14. The axial passage 14 is in communication with a radial passage 39 formed in the shaft portion 6 of the piston bolt 5.

The radial passage 39 is in communication with the extension-side passage 19 via an annular passage 41 formed at the lower end portion of the axial hole 4 of the piston 3, a plurality of cutouts 42 formed on the inner peripheral portion 17 of the piston 3, and the disk valve 40 provided on the piston 3. The disk valve 40 is in abutment with an annular seat portion 43 in a seatable and separable manner. The seat portion 43 is provided on the inner peripheral side of the piston 3 with respect to the seat portion 24 and the opening of the extension-side passage 19. The disk valve 40 is a check valve that permits a flow of the hydraulic fluid from the radial passage 39 to the extension-side passage 19.

The compression-side back-pressure chamber 55 is in communication with a radial passage 64 formed in the shaft portion 6 of the piston bolt 5 via an orifice 67 provided on the inner peripheral portion of the check valve 63, a width-across-flats portion 77 formed on the shaft portion 6 of the piston bolt 5, and an annular passage 68 formed on the inner peripheral portion of the bottom portion 57 of the compression-side pilot case 52. The radial passage 64 is in communication with the axial passage 12 via a hole 66 formed on the side wall of the sleeve 15.

The radial passage 64 is in communication with the compression-side passage 20 via the width-across-flats portion 77, an annular passage 71 formed at the upper end portion of the axial hole 4 of the piston 3, a plurality of cutouts 72 formed on the inner peripheral portion 17 of the piston 3, and the disk valve 70 provided on the piston 3. The disk valve 70 is in abutment with an annular seat portion 73 in a seatable and separable manner. The seat portion 73 is provided on the inner peripheral side of the piston 3 with respect to the seat portion 54 and the opening of the compression-side passage 20. The disk valve 70 is a check valve that permits a flow of the hydraulic fluid from the radial passage 64 to the compression-side passage 20.

A flow of the hydraulic fluid in the common passage 11 is controlled by a pilot valve 81 (a pilot control valve). The pilot valve 81 includes a valve spool 82 and a seat portion 83. The valve spool 82 is slidably provided in the common passage 11. The seat portion 83 is formed on the circumferential edge of the opening of the axial passage 14 at the bottom portion of the hole 16. The valve spool 82 is made of a solid shaft, and includes a slidable portion 84, a valve body 85, and a connection portion 86. The slidable portion 84 is inserted in the sleeve 15. The valve body 85 is in abutment with the seat portion 83 in a seatable and separable manner. The connection portion 86 connects the slidable portion 84 and the valve body 85.

A head portion 87 of the valve spool 82 is formed at the upper end of the slidable portion 84. A spring bearing portion 88 shaped like an outer flange is formed at the lower end portion of the head portion 87. The inner peripheral portion of a spring disk 113 is connected to the spring bearing portion 88. The spring disk 113 biases the valve body 85 in a valve-opening direction. Due to this configuration, the head portion 87 of the valve spool 82 is placed in abutment with (is pressed against) a lower end surface 93 of an actuation rod 92 of a solenoid 91. A first chamber 130 is formed on the outer periphery of the head portion 87 of the valve spool 82.

A bottomed cylindrical cap 121, which is opened at the upper end side thereof, is attached to an outer peripheral surface 36 of the head portion 7 of the piston bolt 5. An insertion hole 123 is provided at a bottom portion 122 of the cap 121. The shaft portion 6 of the piston bolt 5 is inserted through the insertion hole 123. A plurality of cutouts 124 ("two" cutouts 124 are illustrated in FIG. 5) is provided on the outer periphery of the insertion hole 123. The cutouts 124 are in communication with the width-across-flats portion 77 formed on the shaft portion 6. An annular groove 127 is provided on the outer peripheral surface 36 of the head portion 7 of the piston bolt 5. A seal member 128 is set in the annular groove 127. The seal member 128 seals between the head portion 7 of the piston bolt 5 and a cylindrical portion 125 of the cap 121. An annular second chamber 131 is formed between the head portion 7 of the piston bolt 5 and the cap 121.

A spool back-pressure relief valve 107, a spacer 108, and a retainer 132 are provided between the head portion 7 of the piston bolt 5 and the bottom portion 122 of the cap 121 in this order starting from the head portion 7 side. The spool back-pressure relief valve 107, the spacer 108, and the retainer 132 are provided in the second chamber 131. The spool back-pressure relief valve 107 is a check valve that permits a flow of the hydraulic fluid from the first chamber 130 to the second chamber 131 via a passage 105 formed in the head portion 7. The outer peripheral edge portion of the spool back-pressure relief valve 107 is in abutment with an annular seal portion 109 in a seatable and separable manner. The seat portion 109 is formed on the lower end surface of the head portion 7 of the piston bolt 5.

A plurality of cutouts 133 is provided on the inner peripheral edge portion of the retainer 132. The plurality of cutouts 133 establishes communication of the second chamber 131 with the width-across-flats portion 77 and the cutouts 124 of the cap 121. A retainer 59 is interposed between the bottom portion 122 of the cap 121 and the sub valve 60. The retainer 59 defines a maximum valve-opening amount of the sub valve 60.

A fail-safe valve 111 is constructed in the first chamber 130. The fail-safe valve 111 includes a disk 112 (a valve seat). The spring bearing portion 88 (a valve body) of the head portion 87 of the valve spool 82 is in abutment with the disk 112 in a seatable and separable manner. The outer peripheral edge portions of the disk 112 and the spring disk 113 are held between the head portion 7 of the piston bolt 5 and a core 99 of the solenoid 91. Then, in a failure state (a state in which the thrust force of the solenoid 91 is zero), the fail-safe valve 111 is closed due to the spring bearing portion 88 placed in abutment with (pressed against) the disk 112 under the biasing force of the spring disk 113.

As illustrated in FIG. 1, the solenoid 91 includes the actuation rod 92, the solenoid case 94, and a coil 95. A plunger 96 is coupled with the outer periphery of the actuation rod 92. The plunger 96 generates a thrust force by power supply to the coil 95. A rod inner passage 97 is formed inside the actuation rod 92. The actuation rod 92 is guided vertically (axially) by a bush 100 provided in a core 98.

As illustrated in FIG. 2, an annular groove 115 is formed on the outer peripheral surface of the core 99. A seal member 116 is set in the annular groove 115. The seal member 116 seals between the lower end portion of the solenoid case 94 and the core 99. Due to this configuration, an annular passage 117 is formed between the piston bolt 5 and the core 99 of the solenoid case 94. The annular passage 117 is in communication with the cylinder upper chamber 2A via a passage 118 provided at the lower end portion of the cylindrical portion 8 of the piston bolt 5.

A spool back-pressure chamber 101 is formed inside the core 99 of the solenoid 91. The spool back-pressure chamber 101 is in communication with a rod back-pressure chamber 103 via a cutout 102 of the actuation rod 92 and the rod inner passage 97. Then, when no power is supplied to the coil 95, the valve spool 82 is biased in a valve-opening direction of the pilot valve 81 (the valve body 85) (the "upward direction" in FIG. 4) under the biasing force of the spring disk 113, and the spring bearing portion 88 is kept in abutment with the disk 112. Due to this abutment, the communication between the spool back-pressure chamber 101 and the first chamber 130 is blocked.

Then, when power is supplied to the coil 95, the valve spool 82 is biased in a valve-closing direction of the pilot valve 81 (the valve body 85) (the "downward direction" in FIG. 2) under the thrust force generated by the plunger 96. Accordingly, the valve spool 82 is moved against the biasing force of the spring disk 113, and the valve body 85 is seated on the seat portion 83. Now, the valve-opening pressure of the pilot valve 81 can be adjusted by controlling the power supply to the coil 95. At the time of a soft mode in which power is supplied to the coil 95 with a low current value, the biasing force of the spring disk 113 and the thrust force generated by the plunger 96 are balanced, and the valve body 85 is kept in a state of being separated from the seat portion 83 by a predetermined distance.

(Extension Stroke) During the extension stroke, the hydraulic fluid in the cylinder upper chamber 2A is introduced into the extension-side back-pressure chamber 25 via an upstream-side back-pressure introduction passage, i.e., the extension-side passage 19, the orifice 44 formed on the disk valve 40, the cutouts 42 formed on the piston 3, the annular passage 41 formed in the axial hole 4 of the piston 3, the radial passage 39, the axial passage 14, the radial passage 34, the annular passage 38 formed in the extension-side pilot case 22, and the orifice 37 formed on the check valve 33.

Further, during the extension stroke, the hydraulic fluid in the cylinder upper chamber 2A (a chamber on an upstream side) is introduced into the compression-side back-pressure chamber 55 via the compression-side communication passage, i.e., the first orifice 185, the second pressure-receiving chamber 187, the back-pressure introduction passage 181, and the check valve 63. As a result, the compression-side main valve 53 can be prevented from being opened under the pressure in the cylinder upper chamber 2A during the extension stroke.

Further, the hydraulic fluid introduced into the compression-side back-pressure chamber 55 during the extension stroke flows to the cylinder lower chamber 2B (a chamber on a downstream side) via the orifice 67 formed on the check valve 63, the width-across-flats portion 77 formed on the shaft portion 6 of the piston bolt 5, the annular passage 68 formed on the inner peripheral portion of the bottom portion 57 of the compression-side pilot case 52, the cutouts 72 formed on the inner peripheral portion 17 of the piston 3, the disk valve 70, and the compression-side passage 20, and therefore a damping force according to an orifice characteristic due to the orifice 67 and a valve characteristic due to the disk 70 can be acquired before the extension-side main valve 23 is opened, i.e., in the region where the piston speed is a low speed.

Then, during the extension stroke, when the pressure in the cylinder upper chamber 2A exceeds the pressure in the compression-side back-pressure chamber 55, the hydraulic oil in the cylinder upper chamber 2A may enter into between the low-rigidity disk 163 seated on the seat portion 54 (the outer seat portion) and the disk 162 adjacent to this low-rigidity disk 163, and the low-rigidity disk 163 may be deformed.

On the other hand, the first embodiment causes the inner peripheral portion of the low-rigidity disk 163 to be supported by the backup disk 164 (the deformation prevention portion), thereby being able to shift the support point of the low-rigidity disk 163 on the inner peripheral side from P1 (the outer peripheral end of the spacer 165) to P3 (the outer peripheral end of the backup disk 164) located on the outer peripheral side (the left side in FIG. 3), i.e., shorten the moment length of the low-rigidity disk 163 (the distance between the support points) from L1 to L2 by L3, and thus increase the bending rigidity of the low-rigidity disk 163.

### Compression Stroke

During the compression stroke, the hydraulic fluid in the cylinder lower chamber 2B (the chamber on the upstream side) is introduced into the compression-side back-pressure chamber 55 via an upstream-side back-pressure introduction passage, i.e., the compression-side passage 20, the orifice 74 formed on the disk valve 70, the cutouts 72 formed on the piston 3, the annular passage 71 formed in the axial hole 4 of the piston 3, the width-across-flats portion 77 formed on the shaft portion 6 of the piston bolt 5, and the orifice 67 formed on the check valve 63.

Further, during the compression stroke, the hydraulic fluid in the cylinder lower chamber 2B (the chamber on the upstream side) is introduced into the extension-side back-pressure chamber 25 via the extension-side communication passage, i.e., the first orifice 175, the second pressure-receiving chamber 177, the back-pressure introduction passage 171 (the downstream-side back-pressure introduction passage), and the check valve 33. As a result, the extension-side main valve 23 can be prevented from being opened under the pressure in the cylinder lower chamber 2B during the compression stroke.

Further, the hydraulic fluid introduced into the extension-side back-pressure chamber 25 during the compression stroke flows to the cylinder upper chamber 2A (the chamber on the downstream side) via the orifice 37 formed on the check valve 33, the annular passage 38 formed on the inner peripheral portion of the bottom portion 27 of the extension-side pilot case 22, the radial passage 34, the axial passage 14, the radial passage 39, the annular passage 41 formed in the axial hole 4 of the piston 3, the cutouts 42 formed on the inner peripheral portion 17 of the piston 3, the disk valve 40, and the extension-side passage 19, and therefore a damping force according to an orifice characteristic due to the orifice 37 and a valve characteristic due to the disk 40 can be acquired before the compression-side main valve 53 is opened, i.e., in the region where the piston speed is a low speed.

Then, during the compression stroke, when the pressure in the cylinder lower chamber 2B exceeds the pressure in the extension-side back-pressure chamber 25, the hydraulic oil in the cylinder lower chamber 2B may enter into between the low-rigidity disk 143 seated on the seat portion 24 (the outer seat portion) and the disk 142 adjacent to this low-rigidity disk 143, and the low-rigidity disk 143 may be deformed.

On the other hand, the first embodiment causes the inner peripheral portion of the low-rigidity disk 143 to be supported by the backup disk 144 (the deformation prevention portion), thereby being able to shift the support point of the low-rigidity disk 143 on the inner peripheral side from P1 (the outer peripheral end of the spacer 145) to P3 (the outer peripheral end of the backup disk 144) located on the outer peripheral side (the right side in FIG. 3), i.e., shorten the moment length of the low-rigidity disk 143 (the distance between the support points) from L1 to L2 by L3, and thus increase the bending rigidity of the low-rigidity disk 143.

Conventionally, using a low-rigidity disk as the disk seated on (placed in abutment with) the seat portion (the outer seat portion) of the main valve to acquire a damping force according to the soft characteristic has raised a possibility of entry of the hydraulic oil into between the low-rigidity disk seated on the seat portion (the outer seat portion) and the disk adjacent to this low-rigidity disk upon an increase in the pressure in the cylinder upper chamber over the pressure in the compression-side back-pressure chamber, for example, during the extension stroke, thereby leading to a deformation of the low-rigidity disk and a reduction in the durability.

On the other hand, the first embodiment causes the inner peripheral portion of the low-rigidity disk 163 to be supported by the backup disk 164 (the deformation prevention portion), thereby shifting the support point of the low-rigidity disk 163 on the inner peripheral side from P1 (the outer peripheral end of the spacer 165) to P3 (the outer peripheral end of the backup disk 164) located on the outer peripheral side, for example, during the extension stroke.

Due to that, the moment length of the low-rigidity disk 163 (the distance between the support points) is shortened from the difference between the radius of the low-rigidity disk 163 and the radius of the spacer 165 ("L1" in FIG. 5) to the difference between the radius of the low-rigidity disk 163 and the radius of the backup disk 164 ("L2" in FIG. 5), and the bending rigidity of the low-rigidity disk 163 is improved.

As a result, the low-rigidity disk 163 can be prevented from being deformed due to the inflow of the hydraulic oil to between the low-rigidity disk 163 and the disk 162 adjacent thereto according to the increase in the pressure in the cylinder upper chamber 2A during the extension stroke, thereby being prevented from incurring damage. Further, during the compression stroke, the valve-opening of the low-rigidity disk 163 is not blocked by the backup disk 164, and therefore a damping force according to a low valve characteristic can be acquired similarly to the conventional technique.

During the compression stroke, advantageous effects similar to the above-described advantageous effects during the extension stroke can also be achieved.

### Second Embodiment

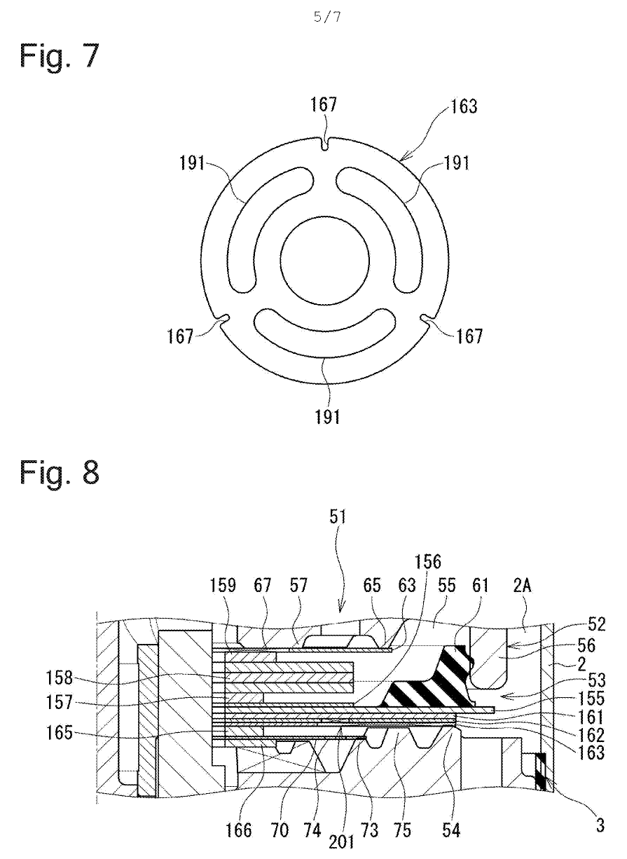

Next, a second embodiment will be described with reference to FIGS. 6 and 7.

The second embodiment will be described, assigning the same names and reference numerals to portions shared with the first embodiment, and omitting redundant descriptions thereof. Further, the extension-side main valve 23 and the compression-side main valve 53 have the same basic structures, similarly to the first embodiment. Therefore, the second embodiment will be described focusing on related portions of the compression-side main valve 53 and omitting the descriptions of the related portions of the extension-side main valve 23.

The first embodiment is configured to cause the inner peripheral portion of the low-rigidity disk 163 to be supported by the backup disk 164 (the deformation prevention portion), thereby preventing the low-rigidity disk 163 from being deformed due to the inflow of the hydraulic oil to between the low-rigidity disk 163 and the disk 162 adjacent thereto according to the increase in the pressure in the cylinder upper chamber 2A during the extension stroke.

On the other hand, in the second embodiment, a plurality of ("three" in the second embodiment) holes 191 (the deformation prevention portion) is formed on the low-rigidity disk 163 without use of the backup disk 164 (refer to FIG. 5). The holes 191 establish constant communication between one side (the compression-side back-pressure chamber 55 side) and the opposite side (the piston 3 side) of this low-rigidity disk 163. The holes 191 are elongated holes provided on the inner peripheral side with respect to the seat portion 75 (the inner seat portion) and circumferentially extending between the adjacent cutouts 167.

The second embodiment allows the hydraulic oil flowing into between the low-rigidity disk 163 and the disk 162 adjacent thereto due to the increase in the pressure in the cylinder upper chamber 2A during the extension stroke, i.e., the hydraulic oil flowing into the one side of the low-rigidity disk 163 to be released to the opposite side of the low-rigidity disk 163, and, due to a reduction in the stress applied to the low-rigidity disk 163, can prevent this low-rigidity disk 163 from being deformed. The hydraulic oil (the pressure) released to the opposite side of the low-rigidity disk 163 flows (propagates) to the cylinder lower chamber 2B via the compression-side passage 20.

According to the second embodiment, advantageous effects similar to the above-described first embodiment can be achieved.

### Third Embodiment

Next, a third embodiment will be described with reference to FIGS. 8 to 11.

The third embodiment will be described, assigning the same names and reference numerals to portions shared with the first embodiment, and omitting redundant descriptions thereof. Further, the extension-side main valve 23 and the compression-side main valve 53 have the same basic structures, similarly to the first embodiment. Therefore, the third embodiment will be described focusing on related portions of the compression-side main valve 53 and omitting the descriptions of the related portions of the extension-side main valve 23.

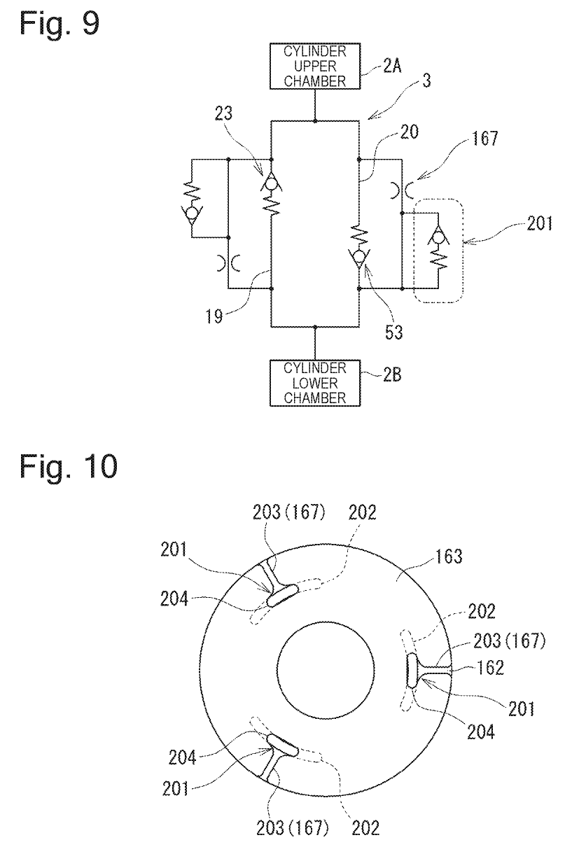

The third embodiment does not use the backup disk 164 that supports the low-rigidity disk 163 (refer to FIG. 5), similarly to the second embodiment. In the third embodiment, a check valve 201 (the deformation prevention portion) is provided between the low-rigidity disk 163 and the piston 3 (the passage formation member) as illustrated in FIGS. 8 and 9. As illustrated in FIG. 10, the check valve 201 includes a plurality ("three" in the third embodiment) of elongated holes 202 formed on the adjacent disk 162 in correspondence with the cutouts 167 of the low-rigidity disk 163, respectively. These elongated holes 202 are evenly disposed along the same circle having a smaller radius than the radius of the seat portion 75 (the inner seat portion).

Further, the check valve 201 includes a plurality of ("three" in the third embodiment) of radial cutouts 203. The radial cutouts 203 are formed on the low-rigidity disk 163, and are provided by extending the respective cutouts 167 toward an axial hole 168 in the radial direction of the low-rigidity disk 163 to reach the respective corresponding elongated holes 202 on the adjacent disk 162. Further, the check valve 201 includes a plurality of ("three" in the third embodiment) of circumferential cutouts 204 provided in correspondence with the respective radial cutouts 203 and circumferentially extending.

As illustrated in FIG. 10, the radial cutouts 203 and the circumferential cutouts 204 define generally T-like shapes, and the circumferential cutouts 204 are disposed so as to be opened (face) the elongated holes 202 corresponding thereto, respectively. Now, the circumferential length of the circumferential cutout 204 is shorter than the circumferential length of the elongated hole 202. Due to that, the check valve 201 is constructed so as to release the hydraulic oil flowing into between the low-rigidity disk 163 and the disk 162 adjacent thereto due to the increase in the pressure in the cylinder upper chamber 2A during the extension stroke, i.e., the hydraulic oil flowing to the one side of the low-rigidity disk 163 to the opposite side of the low-rigidity disk 163.

The third embodiment allows the hydraulic oil flowing into between the low-rigidity disk 163 and the disk 162 adjacent thereto due to the increase in the pressure in the cylinder upper chamber 2A during the extension stroke to be released to the cylinder lower chamber 2B via the elongated holes 202 of the disk 162, the circumferential cutouts 204 of the low-rigidity disk 163, and the compression-side passage 20, and therefore can prevent the low-rigidity disk 163 from being deformed due to the inflow of the hydraulic oil to between the disks 162 and 163, thereby preventing the low-rigidity disk 163 from incurring damage.

The third embodiment can achieve advantageous effects similar to the above-described first and second embodiments.

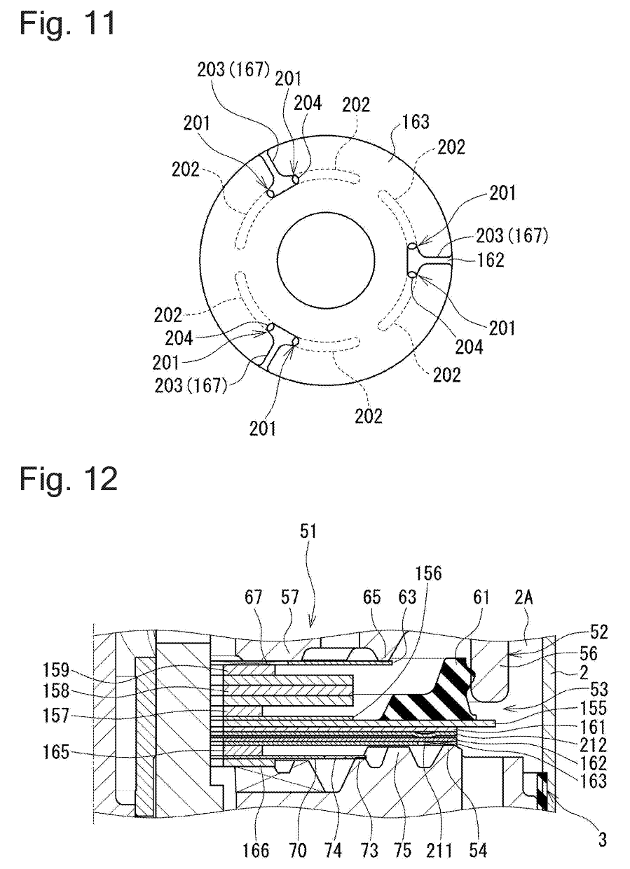

The third embodiment may be modified in such a manner that the check valve 201 is constructed by forming two elongated holes 202 on the disk 162 for a single circumferential cutout 204 on the low-rigidity disk 163, and causing the end portions of the circumferential cutout 204 on both the circumferential sides to be opened to the respective end portions of the adjacent elongated hole 202, as illustrated in FIG. 11.

### Fourth Embodiment

Next, a fourth embodiment will be described with reference to FIG. 12.

The fourth embodiment will be described, assigning the same names and reference numerals to portions shared with the first embodiment, and omitting redundant descriptions thereof. Further, the extension-side main valve 23 and the compression-side main valve 53 have the same basic structures, similarly to the first embodiment. Therefore, the fourth embodiment will be described focusing on related portions of the compression-side main valve 53 and omitting the descriptions of the related portions of the extension-side main valve 23.

The fourth embodiment does not use the backup disk 164 that supports the low-rigidity disk 163 (refer to FIG. 5), similarly to the second and third embodiments. In the fourth embodiment, a disk 212 with an intermediate protrusion portion 211 (the deformation prevention portion) formed thereon is interposed between the disk 162 adjacent to the low-rigidity disk 163 and the disk 161 adjacent to the main disk 155, as illustrated in FIG. 12. The outer diameter of the disk 212 is equal to the outer diameters of the disks 161 to 163.

The intermediate protrusion portion 211 is disposed between the seat portion 54 (the outer seat portion) and the seat portion 75 (the inner seat portion) formed on the piston 3 (the passage formation member) with the disk 212 mounted on the compression-side valve mechanism 51. The intermediate protrusion portion 211 protrudes toward the low-rigidity disk 163 side beyond a lower surface 213 of the disk 212, and presses the outer peripheral edge portion of the disk 162 against the low-rigidity disk 163 to establish close contact therebetween.

The intermediate protrusion portion 211 is formed on the metallic disk 212 by stamping, and extends along the outer peripheral edge of the disk 212. The intermediate protrusion portion 211 is circularly (endlessly) formed, but may be constructed by evenly disposing a plurality of circumferentially extending protrusion portions (islands) or may be constructed by evenly disposing protrusions along the same circle (disposing protrusions at even intervals or equal intervals).

The fourth embodiment presses the outer peripheral edge portion of the adjacent disk 162 against the low-rigidity disk 163 to establish close contact therebetween with the aid of the intermediate protrusion portion 211 formed on the disk 212, and therefore the hydraulic oil does not flow into between the low-rigidity disk 163 and the disk 162 adjacent thereto even when the pressure in the cylinder upper chamber 2A increases during the extension stroke. As a result, the fourth embodiment can prevent the low-rigidity disk 163 from being deformed due to the inflow of the hydraulic oil to between the disks 162 and 163, thereby preventing the low-rigidity disk 163 from incurring damage.

The fourth embodiment can achieve advantageous effects similar to the above-described first to third embodiments.

The embodiments are not limited to the above-described examples, and, for example, can be configured in the following manner.

The pilot cases 22 and 52 (the case member) with the back-pressure chambers 25 and 55 formed therein are fixed to the piston bolt 5 in the first to fourth embodiments, but the present embodiments can also be applied to a valve mechanism structured in such a manner that a case member with a back-pressure chamber formed therein is moved when a main valve is opened, i.e., a so-called conventional-type shock absorber not including an actuator (a solenoid).

Further, the first to fourth embodiments have been described citing a so-called built-in piston type damping force adjustable shock absorber in which the damping force generation mechanism including the actuator (the solenoid) is built in the cylinder 2 by way of example, but the present embodiments can be applied to a so-called control valve side-mounting damping force adjustable hydraulic shock absorber in which a damping force generation mechanism is attached to the side wall of an outer tube (a cylinder) alongside.

The present invention shall not be limited to the above-described embodiments, and includes various modifications. For example, the above-described embodiments have been described in detail to facilitate a better understanding of the present invention, and the present invention shall not necessarily be limited to the configuration including all of the described features. Further, a part of the configuration of some embodiment can be replaced with the configuration of another embodiment. Further, some embodiment can also be implemented with a configuration of another embodiment added to the configuration of this embodiment. Further, each embodiment can also be implemented with another configuration added, deleted, or replaced with respect to a part of the configuration of this embodiment.

The present application claims priority under the Paris Convention to Japanese Patent Application No. 2021-016764 filed on February 4, 2021. The entire disclosure of Japanese Patent Application No. 2021-016764 filed on February 4, 2021 including the specification, the claims, the drawings, and the abstract is incorporated herein by reference in its entirety.

### REFERENCE SIGNS LIST

1 shock absorber

2 cylinder

3 piston (passage formation member)

10 piston rod

19 extension-side passage

20 compression-side passage

22 extension-side pilot case (case member)

23 extension-side main valve

24 seat portion (outer seat portion)

25 extension-side back-pressure chamber

45 seat portion (inner seat portion)

52 compression-side pilot case (case member)

53 compression-side main valve

54 seat portion (outer seat portion)

55 compression-side back-pressure chamber

75 seat portion (inner seat portion)

143 low-rigidity disk

144 backup disk (deformation prevention portion)

163 low-rigidity disk

164 backup disk (deformation prevention portion)

1. A shock absorber comprising:
a cylinder sealingly containing hydraulic fluid therein;
a piston movably provided in the cylinder and partitioning an inside of the cylinder into two chambers;
a piston rod having one end side coupled with the piston and an opposite end side extending out of the cylinder;
a passage in which a flow of the hydraulic fluid is generated due to a movement of the piston in one direction;
the piston including the passage formed therein;
a main valve configured to apply a resistance force to a flow of the hydraulic fluid passing through the passage from a chamber on an upstream side to a chamber on a downstream side;
a back-pressure chamber configured to apply an inner pressure in a valve-closing direction of the main valve; and
a bottomed tubular case member, the bottomed tubular case member including a tube portion and a bottom portion, the tube portion including an opening portion opened on one end side thereof, the main valve being disposed in the opening portion, the back-pressure chamber being formed inside the bottomed tubular case member,
the shock absorber further comprising:
an inner seat portion provided on the piston and disposed on an inner peripheral side with respect to an opening of the passage;
an outer seat portion provided on the piston and disposed on an outer peripheral side with respect to the opening of the passage;
a low-rigidity disk configured to be seated on the outer seat portion and having lower rigidity than the main valve; and
a deformation prevention portion configured to prevent the low-rigidity disk from being deformed,
wherein the deformation prevention portion is a hole configured to allow the pressure of the hydraulic fluid flowing into one side of the low-rigidity disk to be released to an opposite side of the low-rigidity disk.

2. The shock absorber according to claim 1, wherein the main valve is a packing valve.

3. The shock absorber according to claim 1, wherein the case member is provided movably relative to the main valve.

4. The shock absorber according claim 1, wherein a check valve is provided between the low-rigidity disk and the piston.

5. The shock absorber according to claim 1, wherein an intermediate protrusion portion protruding toward the main valve side is provided between the outer seat portion and the inner seat portion.
